(19) United States
(12) Patent Application Publication
(10) Pub. No.: US 2014/0089960 A1
(43) Pub. Date: Mar. 27, 2014

(54) INTERACTIVE SYSTEM

(71) Applicant: Anthony Robert FARAH, Concord West NSW (AU)

(72) Inventor: Anthony Robert FARAH, Concord West NSW (AU)

(21) Appl. No.: 14/036,928

(22) Filed: Sep. 25, 2013

(30) Foreign Application Priority Data
Sep. 26, 2012 (AU) 2012904204

(51) Int. Cl. H04H 60/33

(52) U.S. Cl. CPC H04H 60/33
USPC 725/24

(57) ABSTRACT

Disclosed herein are a method and system for facilitating audience feedback during an event. The method includes receiving at least one input request from a set of registered audience members of the event, wherein each request relates to a predefined set of actions. The method processes the received requests and presents information during the event, based on the processed requests.

### CROSS-REFERENCE TO RELATED APPLICATIONS

This application claims priority to and the benefit of Australian Provisional Patent Application No. 2012904204 entitled “Interactive system”, filed on 26 Sep. 2012 in the name of Anthony Robert Farah, the entire contents of which are incorporated herein by reference.

### TECHNICAL FIELD

The present application relates generally to live events and, in particular, to a method and system for facilitating viewer interaction with live events.

### BACKGROUND

Live events, such as sporting contests and performances of the fine arts, are commonly performed for a live audience at an event venue. Event venues include, for example, stadiums, concert halls, playing fields, auditoriums, theatres, and the like. Live events typically involve at least one performer. For example, a musical performance may involve a solo performer, a small number of performers, an orchestra, a massed choir, or any combination thereof. A sporting contest will generally involve at least two competitors, as either teams or individuals, and may involve one or more officials, such as a referee or judge.

The size of an event venue imposes a limit on the number of people who can be physically present at any one event. Accordingly, it is common to broadcast live audio and/or video content relating to the event, so that the live audience can be greatly increased beyond the capacity of the event venue. The broadcasting of audio or video content may include, for example, radio, television, and streaming over wired and wireless communication networks, such as the Internet. Thus, it is common for events to be viewed by a live audience that includes persons physically present at the event venues and persons that view or listen to the event on radios, televisions, computer screens, monitors, or other devices at one or more remote locations.

Audio or video content of an event is often supplemented by commentary. Video content may also be supplemented by graphics relating to the event, such as timing, scores, participants, and other statistics. The commentary and graphics are provided to the live audience to provide the audience with a richer and more informed experience of the event.

In some contests, such as sporting events or eisteddfods, there is limited correlation between the opinion of the viewing audience and the adjudicating officials. This may arise due to the ignorance of the viewing audience or due to the viewing audience having access to more information than the adjudicating officials, such as may occur when the viewing audience has access to multiple viewing angles and the official only has access to a single viewing angle.

Individuals who comprise part of the live audience physically present at an event venue are able to provide feedback in the form of physical gestures and comments during the event. Such gestures and comments may be as encouragement to a competitor or performer supported by the audience member or as derision of a competitor or performer not supported by the audience member. Similarly, such physical gestures and comments may be directed at an official in response to a decision, action, or even lack of action made by that official. At a musical performance, an audience member physically present at the event may shout out the name of a favourite song, for example, in the hope that the performer(s) will play that song. The audience member may also jeer in response to a poor performance by a performer.

At large events attended by many thousands of audience members, individual gestures or comments may be ineffective, as the base noise level is relatively high and there may be considerable physical distance between the member of the live audience and the performer, contestant, or official that is the target of the gesture or comment. Members of the live audience who are not physically located at the event venue are unable to provide any feedback to the performers, competitors, or officials. Thus, the live audience is restricted in their ability, both as individuals and collectively as a group, to provide feedback to the performers, competitors, or officials.

Live television contests may utilise one or more voting methods, wherein viewers vote after a performance by a contestant. Such votes may be submitted, for example, by Short Message Service (SMS) messages, dialling a dedicated telephone number, or voting online via a hosted website or social media platform. However, such voting methods do not influence the contestants or officials during the live performance of a particular contestant.

Televised debates have recently utilised a continuous response measure to display a graphical representation allowing viewers to track the response of a set of live audience members during the debate. Due to the appearance of the continuous response measure, it is commonly referred to as “the worm”. However, the graphical representation is not presented to the debaters during the debate and the debaters are thus not able to modify their behaviour or arguments in response to the continuous response measure.

There is presently no mechanism for a remote viewer of a live event to provide feedback during an event to competitors and officials, such as judges, referees, and umpires, to affect the outcome of the event.

Thus, a need exists to provide a method and system to facilitate live audience feedback during a live event.

### SUMMARY

In a first aspect, the present disclosure provides a method for facilitating audience feedback during an event, comprising the steps of:

receiving at least one input request from a set of registered audience members of said event, said request relating to a predefined set of actions;

processing said received requests; and

presenting information during said event, based on said processed requests.

In a second aspect, the present disclosure provides an interactive feedback system server comprising:

a memory for storing data and a computer program;

a processor coupled to said memory for executing said computer program stored in said memory;

a registered user database for storing viewer information associated with at least one registered viewer;

an event database for storing event information relating to at least one scheduled event;

an interactive feedback application forming part of said computer program, said interactive feedback application including instructions for performing the method steps of:

registering at least one of said registered viewers as a registered audience member in respect of an active event selected from at least one of said scheduled events;

receiving at least one input request from at least one of said registered audience members during said active event, said request relating to a predefined set of actions;

processing said received input requests; and

presenting information during said event, based on said processed requests.

In a third aspect, the present disclosure provides an interactive feedback system comprising:

a communications network;

an alert device located at a venue associated with a live event;

an interactive feedback server coupled to said communications network, said interactive feedback server adapted to process input requests relating to at least one of judging and refereeing of said live event and further adapted to present information to said alert device based on said processed input requests; and

a computing device for receiving an input request from a registered audience member and transmitting said input request to said interactive feedback server via said communications network.

According to another aspect, the present disclosure provides an apparatus for implementing any one of the aforementioned methods.

According to another aspect, the present disclosure provides a computer program product including a computer readable medium having recorded thereon a computer program for implementing any one of the methods described above.

Other aspects of the present disclosure are also provided.

### BRIEF DESCRIPTION OF THE DRAWINGS

One or more embodiments of the present disclosure will now be described by way of specific example(s) with reference to the accompanying drawings, in which:

FIG. 1 is a flow diagram of a method of facilitating feedback from one or more members of a live audience of an event;

FIG. 2 is a schematic block diagram representation of a system that includes a general purpose computer on which one or more embodiments of the present disclosure may be practised;

FIG. 3 is a schematic block diagram representation of an interactive feedback system;

FIG. 4 is a schematic block diagram representation of an interactive feedback system for judging an event;

FIG. 5 is a schematic block diagram representation of the computing device 430a of FIG. 4 displaying an interface of a predefined set of scoring moves for use in judging an event;

FIG. 6A is a flow diagram of a method of processing feedback from one or more members of a live audience to judge an event;

FIG. 6B is a flow diagram illustrating processing by a system of viewer feedback to judge an event;

FIG. 7 is a schematic block diagram representation of an interactive feedback system for refereeing an event;

FIG. 8 is a flow diagram of a method of processing feedback from one or more members of a live audience to referee an event;

FIG. 9 is a schematic block diagram representation of a system that includes a general smartphone on which one or more embodiments of the present disclosure may be practised;

FIGS. 10A-D are schematic representations illustrating an interactive feedback system applied to an MMA match and using a restart timer;

FIG. 11 is a schematic representation illustrating latency in received input requests; and

FIG. 12 is a flow diagram illustrating a method of processing an input request in an interactive feedback system.

### DETAILED DESCRIPTION

Method steps or features in the accompanying drawings that have the same reference numerals are to be considered to have the same function(s) or operation(s), unless the contrary intention is expressed or implied.

The present disclosure provides a method and system for facilitating live audience feedback during an event. Providing an interactive mechanism delivers an enhanced entertainment experience to members of the live audience.

A viewer of an event utilises a computing device to provide input relating to the event, during the course of the event. The viewer may be located at the event venue or may be listening or watching the event at a location remote from the event venue. The computing device transmits the input via a communications network to a centralised server, which processes the input and utilises the processed input to affect the event. In one implementation, the processed input is utilised to assist in the judging of the event, the refereeing of the event, or a combination thereof. In another implementation, the processed input is utilised to provide a contemporaneous score for the event.

One implementation of the method and system for facilitating live audience feedback utilises a clock to apply a timestamp to received inputs from viewers. This allows the system to correlate inputs and map those inputs to actions in the live event.

In one embodiment, a viewer of an event utilises a computing device, such as a smartphone or tablet device, executing a computer program for managing input relating to a live event. The computer program provides an interface for receiving input from the viewer. In one implementation, the computer program validates the viewer for the particular event. In another implementation, the computer program provides the viewer with a user interface tailored to the event or a type of event. In one example, the event is a mixed martial arts (MMA) event and the interface provides the viewer with a predefined set of judging criteria, scoring criteria, or a combination thereof.

In one implementation, viewers of an event are required to register for the event with the system before being able to provide input relating to that event. Registration of a viewer may include the system allocating a user identifier and password to the viewer. The viewer utilises the user identifier and password to log in to a website or application hosted on a computing device to browse information about a forthcoming event or to interact with a live event. In another implementation, the system for facilitating live audience feedback validates a viewer as a human before accepting input from that viewer. Validation of a viewer as a human may be implemented, for example, using a challenge-response test, such as Captcha. Alternatively, biometric data may be used, such as one or more of fingerprint recognition, voice authentication, and/or facial recognition. In a further implementation, viewers are authenticated using third party references. Such third party references may include, for example, Facebook Login, Twitter Login and/or registered members of clubs participating at a live event.

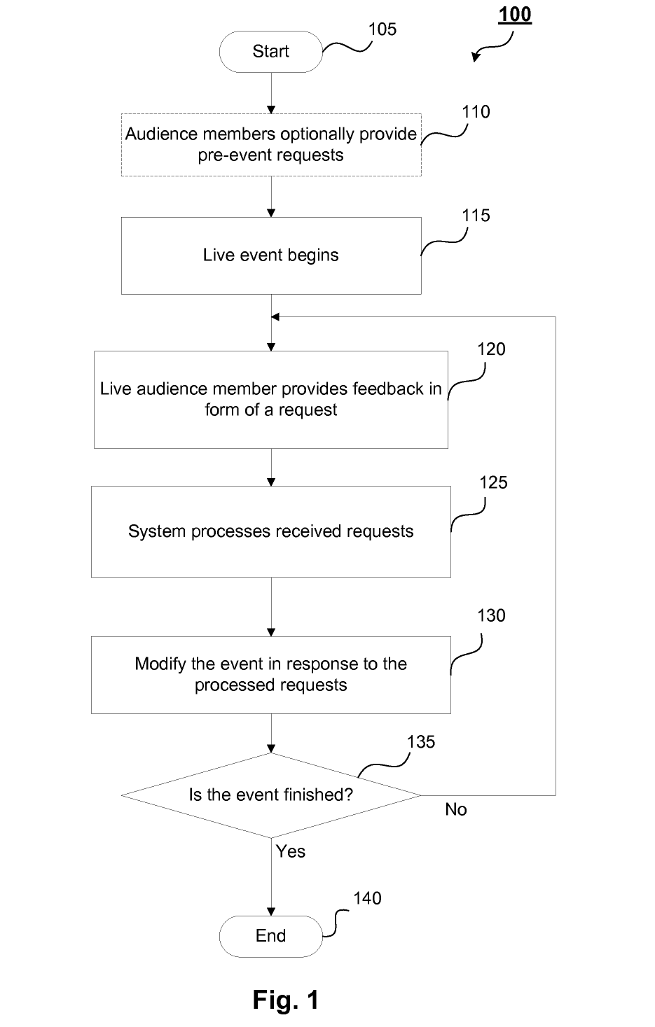

FIG. 1 is a flow diagram illustrating a method 100 of facilitating feedback from one or more members of a live audience of an event. The method 100 begins at a Start step 105 and proceeds to optional step 110, in which members of the live audience are able to provide pre-performance requests via a viewer feedback system.

The feedback system may be implemented, for example, as a software application executing on a computing device. In one implementation, the software application executes on a handheld computing device, such as a smartphone or tablet, and a member of the live audience navigates a user interface provided by the software application to provide input in the form of a request. The computing device transmits the request to a central server operated by an administrator of the system. Such requests may occur at any time before the event commences. Depending on the application, such requests may be restricted to holders of tickets for the live event or to registered users of the feedback system.

In one embodiment, the live event is a musical performance and ticket holders for the musical performance are optionally able to access the feedback system to lodge requests for favourite songs to be performed during the live event. In one implementation, an audience member utilises a serial number associated with a ticket for the event to validate the request. In another implementation, viewers are required to register with the viewer feedback system in relation to a particular event prior to submitting requests relating to that event. The system is thus able to restrict requests associated with an event to bona fide live audience members.

In an alternative embodiment, the live event is a contest between a predefined number of contestants. Prospective audience members are able to vote for one or more contestants to compete in the contest, from a pool of contestants that contains more than the predefined number.

Control passes from step 110 to step 115, in which the event commences. Control then passes to step 120, in which live audience members are able to lodge requests during the event. The request will depend on the type of event, but may include, for example, a request for a particular song, a message of encouragement to a performer or official associated with the event, a message of derision to a performer or official associated with the event, input relating to a scoring system associated with the event, or input relating to officiating or judging the event.

Control passes from step 120 to step 125, in which information derived from one or more requests received from live audience members in step 120 is processed by the central server. Requests received within a predefined time period may be correlated to provide a crowd response to an action within the event.

Control passes from step 125 to step 130, which modifies the live event in response to the processed requests from step 125. In one embodiment, the live event is a musical performance and requests lodged in step 120 relate to requests for songs. If a song receives a predefined number or percentage of requests, step 130 modifies the event by adding the requested song to the playlist for the event. In another embodiment, a score or officiating decision derived from the requests of step 120 is provided to one or more of the performers, the live audience present at the event, the live audience viewing or listening to a broadcast or transmission of the live event, the official(s), or any combination thereof. The modification of the live event may be direct, such as may occur when an officiating or scoring decision is made. Alternatively, modification of the live event may be indirect, when messages of support or derision are displayed at the event venue in response to requests received in step 120 and the event is modified by the response of the performers or officials to those messages.

In an alternative embodiment, the live event is a sporting contest and the requests lodged in step 120 provide live audience feedback in relation to a scoring move by one of the contestants. In response to the requests lodged in step 120, the score of the contest is adjusted and the adjusted score is displayed to the contestants and/or officials, thus modifying the contest. Similarly, the live audience feedback in step 120 in relation to a sporting contest may relate to a decision by an official. If a predefined number or percentage of requests disagree with the decision within a predefined period of time of the decision being made, in step 130 the decision is reversed or alternative action is taken. For example, a portion of a sporting contest may be replayed or reset, or scores may be adjusted in response to the live audience feedback.

Control passes to decision step 135, which determines whether the live event has finished. If the live event has not finished, No, control returns to step 120 and the live audience is able to provide further requests during performance of the live event. If the live event has finished, Yes, control passes from step 135 to an End step 140 and the method 100 terminates.

Depending on the event and the implementation, requests from members of the live audience may be allowed at any time during the event or only during predetermined portions of the event.

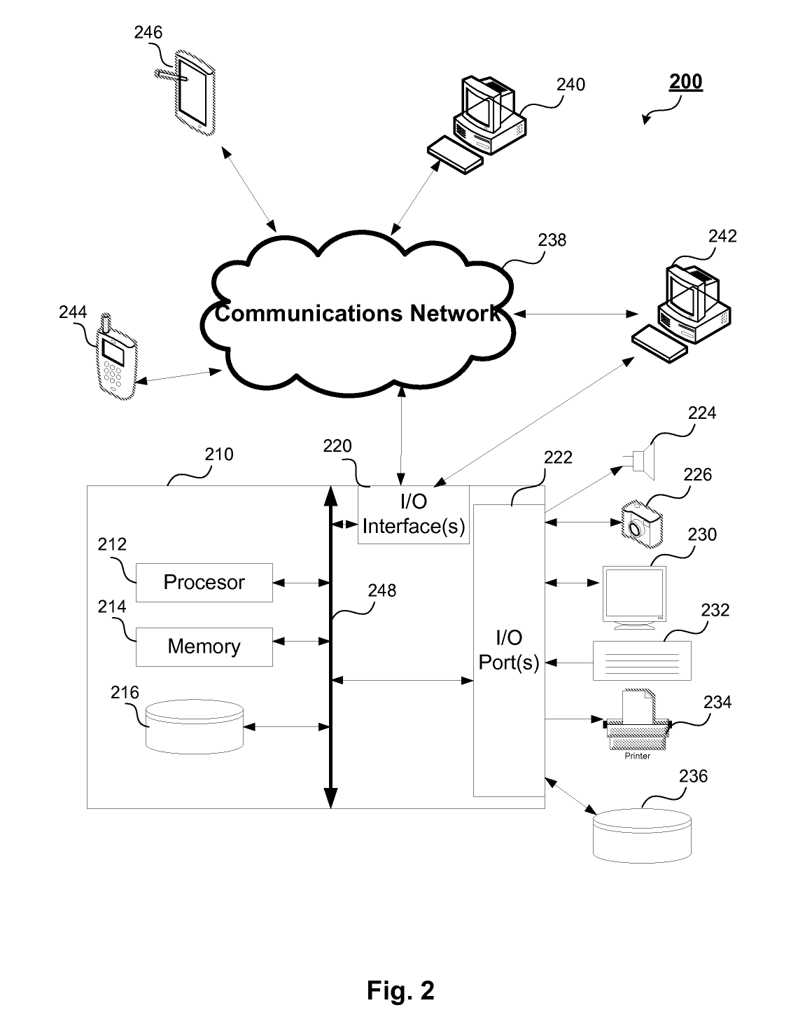

The method and system for facilitating input from live audience members empowers the live audience to modify a live event during the performance and may be practised using a computing device, such as a general purpose computer or computer server. FIG. 2 is a schematic block diagram of a system 200 that includes a general purpose computer 210. The general purpose computer 210 includes a plurality of components, including: a processor 212, a memory 214, a storage medium 216, input/output (I/O) interfaces 220, and input/output (I/O) ports 222. Components of the general purpose computer 210 generally communicate using a bus 248.

The memory 214 may include Random Access Memory (RAM), Read Only Memory (ROM), or a combination thereof. The storage medium 216 may be implemented as one or more of a hard disk drive, a solid state “flash” drive, an optical disk drive, or other storage means. The storage medium 216 may be utilised to store one or more computer programs, including an operating system, software applications, and data. In one mode of operation, instructions from one or more computer programs stored in the storage medium 216 are loaded into the memory 214 via the bus 248. Instructions loaded into the memory 214 are then made available via the bus 248 or other means for execution by the processor 212 to effect a mode of operation in accordance with the executed instructions.

One or more peripheral devices may be coupled to the general purpose computer 210 via the I/O ports 222. In the example of FIG. 2, the general purpose computer 210 is coupled to each of a speaker 224, a camera 226, a display device 230, an input device 232, a printer 234, and an external storage medium 236. The speaker 224 may include one or more speakers, such as in a stereo or surround sound system.

The camera 226 may be a webcam, or other still or video digital camera, and may download and upload information to and from the general purpose computer 210 via the I/O ports 222, dependent upon the particular implementation. For example, images recorded by the camera 226 may be uploaded to the storage medium 216 of the general purpose computer 210. Similarly, images stored on the storage medium 216 may be downloaded to a memory or storage medium of the camera 226. The camera 226 may include a lens system, a sensor unit, and a recording medium.

The display device 230 may be a computer monitor, such as a cathode ray tube screen, plasma screen, or liquid crystal display (LCD) screen. The display 230 may receive information from the computer 210 in a conventional manner, wherein the information is presented on the display device 230 for viewing by a user. The display device 230 may optionally be implemented using a touch screen, such as a capacitive touch screen, to enable a user to provide input to the general purpose computer 210.

The input device 232 may be a keyboard, a mouse, a stylus, or any combination thereof, for receiving input from a user. The external storage medium 236 may be an external hard disk drive (HDD), an optical drive, a floppy disk drive, or a flash drive.

The I/O interfaces 220 facilitate the exchange of information between the general purpose computing device 210 and other computing devices. The I/O interfaces may be implemented using an internal or external modem, an Ethernet connection, or the like, to enable coupling to a transmission medium. In the example of FIG. 2, the I/O interfaces 222 are coupled to a communications network 238 and directly to a computing device 242. The computing device 242 is shown as a personal computer, but may be equally be practised using other computing devices, such as a smartphone, laptop, or a tablet device. Direct communication between the general purpose computer 210 and the computing device 242 may be effected using a wireless or wired transmission link.

The communications network 238 may be implemented using one or more wired or wireless transmission links and may include, for example, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a mobile telephone cellular network, a short message service (SMS) network, or any combination thereof. The general purpose computer 210 is able to communicate via the communications network 238 to other computing devices connected to the communications network 238, such as the mobile telephone handset 244, the touchscreen smartphone 246, the personal computer 240, and the computing device 242.

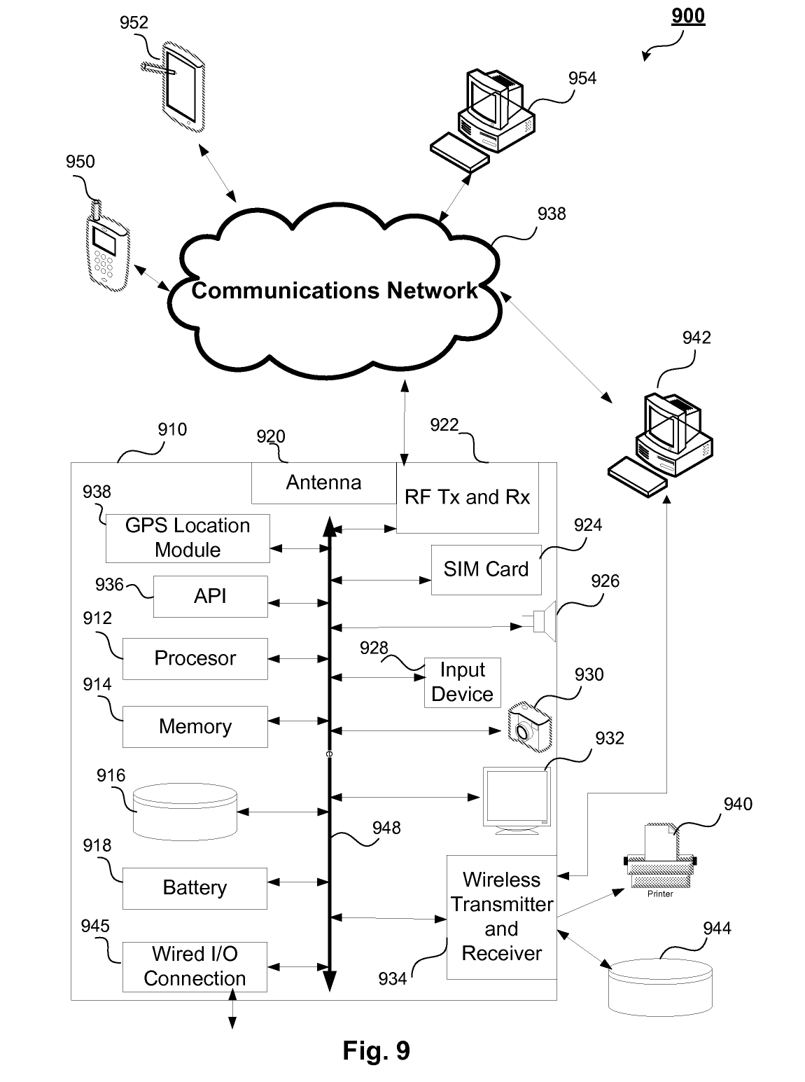

FIG. 9 is a schematic block diagram of a system 900 on which one or more aspects of a viewer feedback system of the present disclosure may be practised. The system 900 includes a portable computing device in the form of a smartphone or computing tablet 910. The smartphone 910 includes a plurality of components, including: a processor 912, a memory 914, a storage medium 916, a battery 918, an antenna 920, a radio frequency (RF) transmitter and receiver 922, a subscriber identity module (SIM) card 924, a speaker 926, an input device 928, a camera 930, a display 932, and a wireless transmitter and receiver 934. Components of the smartphone 910 generally communicate using a bus 948 or other connections therebetween. The smartphone 910 also includes a wired connection 945 for coupling to a power outlet to recharge the battery 918. The wired connection may include one or more connectors and may be adapted to enable uploading and downloading of content from and to the memory 914 and SIM card 924.

The smartphone 910 may include many other functional components, such as an audio digital-to-analogue and analogue-to-digital converter and an amplifier, but those components are omitted for the purpose of clarity. However, such components would be readily known and understood by a person skilled in the relevant art.

The memory 914 may include Random Access Memory (RAM), Read Only Memory (ROM), or a combination thereof. The storage medium 916 may be implemented as one or more of a solid state “flash” drive, a removable storage medium, such as a Secure Digital (SD) or microSD card, or other storage means. The storage medium 916 may be utilised to store one or more computer programs, including an operating system, software applications, and data. In one mode of operation, instructions from one or more computer programs stored in the storage medium 916 are loaded into the memory 914 via the bus 948. Instructions loaded into the memory 914 are then made available via the bus 948 or other means for execution by the processor 912 to effect a mode of operation in accordance with the executed instructions.

The smartphone 910 also includes an application programming interface (API) module 936, which enables programmers to write software applications to execute on the processor 912. Such applications include a plurality of instructions that may be pre-installed in the memory 914 or downloaded to the memory 914 from an external source, via the RF transmitter and receiver 922 operating in association with the antenna 920.

The smartphone 910 further includes a GPS location module 938. The GPS location module 938 is used to determine a geographical position of the smartphone 910, based on GPS satellites, cellular telephone tower triangulation, or a combination thereof. The determined geographical position may then be made available to one or more programs or applications running on the processor 912.

The wireless transmitter and receiver 934 may be utilised to communicate wirelessly with external peripheral devices via Bluetooth, infrared, or other wireless protocol. In the example of FIG. 9, the smartphone 910 is coupled to each of a printer 940, an external storage medium 944, and a computing device 942. The computing device 942 may be implemented, for example, using the general purpose computer 210 of FIG. 2.

The camera 926 may include one or more still or video digital cameras adapted to capture and record to the memory 914 or the SIM card 924 still images or video images, or a combination thereof. The camera 926 may include a lens system, a sensor unit, and a recording medium. A user of the smartphone 910 may upload the recorded images to another computer device or peripheral device using the wireless transmitter and receiver 934, the RF transmitter and receiver 922, or the wired connection 945.

In one example, the display device 932 is implemented using a liquid crystal display (LCD) screen. The display 932 is used to display content to a user of the smartphone 910. The display 932 may optionally be implemented using a touch screen, such as a capacitive touch screen, to enable a user to provide input to the smartphone 910.

The input device 928 may be a keyboard, a stylus, or microphone, for example, for receiving input from a user.

The SIM card 924 is utilised to store an International Mobile Subscriber Identity (IMSI) and a related key used to identify and authenticate the user on a cellular network to which the user has subscribed. The SIM card 924 is generally a removable card that can be used interchangeably on different smartphone or cellular telephone devices. The SIM card 924 can be used to store contacts associated with the user, including names and telephone numbers. The SIM card 924 can also provide storage for pictures and videos. Alternatively, contacts can be stored on the memory 914.

The RF transmitter and receiver 922, in association with the antenna 920, enable the exchange of information between the smartphone 910 and other computing devices via a communications network 938. In the example of FIG. 9, RF transmitter and receiver 922 enable the smartphone 910 to communicate via the communications network 938 with a cellular telephone handset 950, a smartphone or tablet device 952, a computing device 954 and the computing device 942. The computing devices 954 and 942 are shown as personal computers, but each may be equally be practised using a smartphone, laptop, or a tablet device.

The communications network 938 may be implemented using one or more wired or wireless transmission links and may include, for example, a cellular telephony network, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a cellular (mobile) telephone cellular network, a short message service (SMS) network, or any combination thereof.

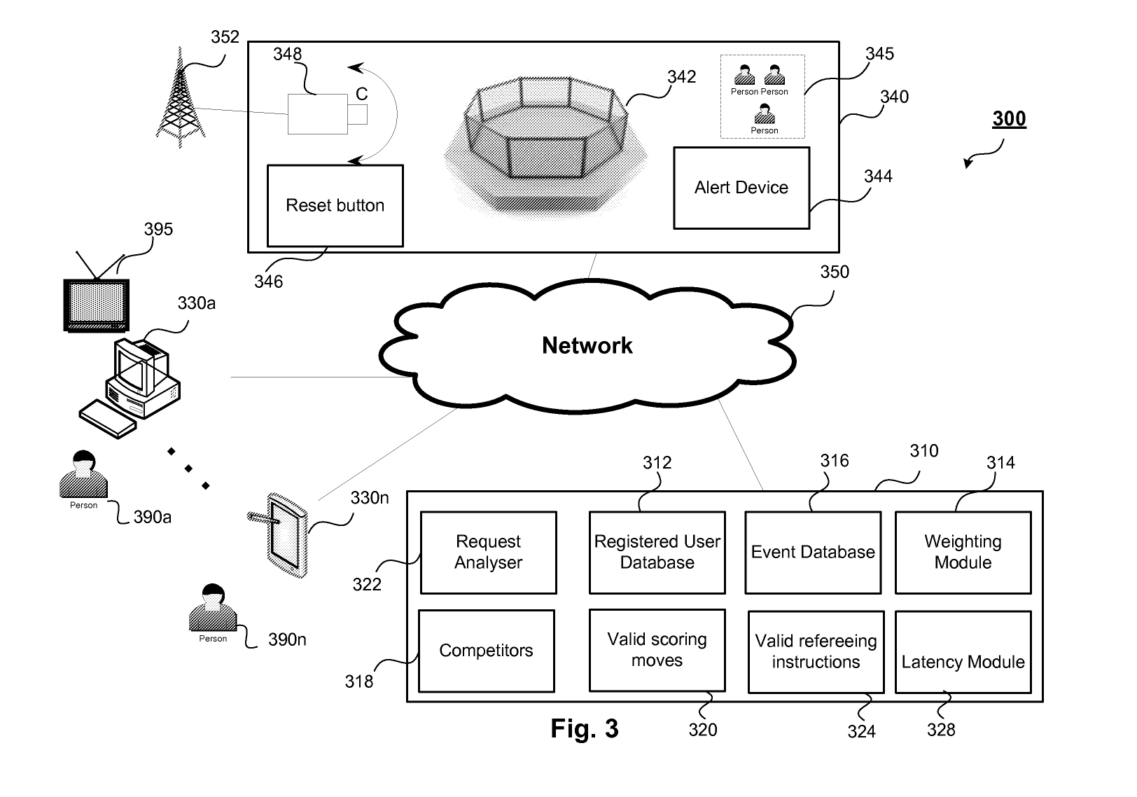

FIG. 3 is a schematic block diagram representation of an interactive feedback system 300 to receive viewer feedback during a live event. The system 300 includes a server 310 coupled to a communications network 350. The server 310 may be implemented using the general purpose computer 210 of FIG. 2, and includes an event register 316, a contestants' register 318, a set of valid scoring moves 320, a set of valid refereeing instructions 324, a request analyser 322, and an audience register 312. The server 310 also optionally includes a weighting module 314 for applying weights to one or more requests received by the server 310. The server 310 further optionally includes a latency module 328 for correcting the latency of different input requests received from different registered viewers.

The system 300 also includes one or more computing devices 330a . . . 330n coupled to the communications network 350. Each of the computing devices 330a . . . 330n may be practised using the general purpose computer 210 of FIG. 2 or the smartphone or tablet device 910 of FIG. 9. The communications network 350 corresponds to the communications network 238 of FIG. 2, and may be implemented using one or more wired or wireless transmission links.

The system 300 further includes an event venue 340 for hosting a live event. As described above, the event venue may be, for example, but is not limited to, a stadium, concert hall, playing field, auditorium, theatre, and the like. In the example of FIG. 3, the event venue 340 includes a performance arena 342, a feedback device 344, and a trigger device 346. The performance arena 342 depends on the actual live event and the event venue, but may include a stage, a playing field, a boxing ring, a mixed martial arts (MMA) cage, or the like. The event venue 340 also includes a live audience 345 present during the event.

The feedback device 344 is used to present information derived from one or more requests received from live audience members, as described in step 125 of FIG. 1. The feedback device 344 may be implemented using an audible warning device, a visual display device, or a combination thereof. For example, the feedback device 344 may be one or more lights, such as a pair of red and green lights to indicate agreement or disagreement with a decision of an official. The feedback device 344 may alternatively be a display screen, such as a Liquid Crystal Display (LCD) screen, a plasma screen, light emitting diode (LED) screen, or the like.

As noted in step 125, the feedback device 344 may be configured to provide feedback to one or more of the performers, the live audience present at the event venue 340, the official(s), or any combination thereof. Thus, where the feedback device 344 is implemented using a display device, the display device may be visible to the performers, the live audience 345 present at the event venue 340, the official(s), or any combination thereof. Similarly, where the feedback device 344 includes an audible warning, that audible warning may be provided to one or more of the performers, the live audience 345 present at the event venue 340, the official(s), or any combination thereof.

In one implementation, the feedback device 344 is broadcast as an audible signal or visual graphic imposed on video footage of the live event.

In one embodiment, a live event occurs at the event venue 340 and a video camera 348 at the event venue 340 captures video footage of the live event. The video camera 348 is coupled to a transmitter 352, which broadcasts the video footage of the live event using radio waves or streaming over the communications network 350.

In the example of FIG. 3, a member 390 of the live audience watches the broadcast video footage on a television or monitor 395, such as the computer display 230 of FIG. 2. That live audience member 390 utilises a computing device 330a to send a request via the communications network 350 to the server 310 during the live event. In one implementation, a software application executes on the computing device 330a to provide the live audience member 390 with an interface to provide requests associated with the live event. In an alternative implementation, the live audience member 390 utilises the computing device 330a to access a website associated with the server 310 to lodge a request relating to the live event.

The server 310 receives the request from the computing device 330a and validates the received request against the set of valid actions 320. The set of valid actions 320 may be specific to a particular live event, event venue, performer, official, or live audience member. In one implementation, the request includes an audience identifier associated with the live audience member 390 and an event identifier associated with the live event being viewed by the live audience member 390. The server 310 validates the live audience member 390 against the audience register 312 and validates the event identifier against the event register 316. If the received request is valid, the request is processed by the request analyser 322.

The request analyser 322 processes the request, optionally interacts with the weighting module 314 to apply any weighting factor and transmits information via the communications network 350 to the feedback device 344. Thus, the live audience member 390 receives an enhanced viewing experience by providing live feedback during the live event.

In one embodiment, the feedback device 344 presents information to an official associated with the live event. Depending upon the information, the official utilises the trigger device 346 to trigger an action. In one embodiment, the trigger device is a restart button, which acts to reset a timer associated with the live event or to provide a visual or audible warning to the contestants or official(s) to restart the live event. For example, if the live event is a mixed martial arts contest, pressing the trigger device 346 indicates to a match official to pull apart two contestants of the mixed martial arts contest and restart the contest.

Some sporting events are objective contests, wherein a winner is determined by comparing the relative performances of the contestants, based, for example, on a recorded time, speed, weight, height, or the like. Thus, the winner of a running event is the contestant with the shortest time for a predefined distance or the longest distance for a predefined time. The winner of a high jump is the contestant who is able to jump successfully over the highest bar. The metrics of time, speed, distance, weight, height, and the like are readily measured in a transparent manner. Neutral judges, calibrated equipment, and photo finishes are utilised to maintain the transparency in determining a winner of a sporting contest. Consequently, it is rare for a live audience member of such an objective contest to disagree with the results of that contest.

Other sporting events require subjective input from one or more officials. For example, football matches are controlled by a set of officials that includes a referee and two linesmen. Throughout the football match, the officials make decisions relating to the fairness of the play, whether a goal has been scored, and timing of the match. Similarly, boxing bouts, martial arts bouts, and mixed martial arts bouts are typically controlled by a set of officials that includes a referee and one or more judges. The referee controls the contestants in the ring and the judges award points during the bout in response to scoring moves identified and recognised by the judges. In sporting events with subjective input from one or more officials, it is common for a live audience member to disagree with a decision made by an official. The disagreement may arise for a number of reasons, including ignorance of the rules by the audience member, different viewing angles of the live audience member and the official, or perceived or real bias by the live audience member and the official.

As noted above, mixed martial arts (MMA) is a sport that includes subjective input from a set of officials that includes a referee and a set of one or more scoring judges. An MMA match typically involves two contestants competing over a predefined number of scheduled scoring rounds of equal duration. MMA is a full contact sport that allows striking, wrestling, and grappling techniques, with points awarded by each scoring judge to the contestants in accordance with predefined criteria.

A result of a match may be declared prior to the match running the full distance, due to submission by a contestant, a technical knockout (TKO), disqualification, or no contest. A TKO may occur by referee stoppage, doctor stoppage, or corner stoppage.

If the match lasts the full distance, the winner is determined by the scores awarded by the judges to the contestants. Each judge provides a score for each of the two contestants. Thus, each judge subjectively identifies a winner of the match, with the winner being the contestant to whom the judge awarded more points. If the judge awarded the same number of points to both contestants, the judge determines the match to be a draw between the contestants. The scores from the set of scoring judges are collated to determine a result for the match. The result for a match may be a winner by unanimous decision of the set of judges, winner by split decision, or a draw.

Incorrect decisions by the referee or a judge may occur due to a number of factors, including, for example: (a) the subjective opinion of the judge; (b) possible lack of attention by the judge during split second scoring events; (c) inability of the judge to see a scoring event; (d) lack of judging experience by the judge; and (e) potential fraud committed by the judge. Consequently, MMA contestants and audience members of MMA events often have a low degree of confidence in the result of a judge scored match being correct.

Anecdotally, MMA contestants know that if a match lasts the scheduled number of rounds, there is no certainty that the decision of the set of judges will necessarily favour the contestant perceived to have delivered the better performance during the event. The decisions of judges during MMA events have known to be contentious and in some cases judges have retrospectively admitted to having misjudged an event.

Due to the lack of confidence in the standard scoring system, it is common for MMA contestants to include a plan to knock out the other opponent in the final round to be certain of victory and not be at the mercy of the vagaries of the subjective scoring judges. Consequently, the current judging/scoring methods can adversely affect the performance and result of a contestant as a contestant who is ahead on points does not know the status of the score during the event and may feel the need to win by knockout by engaging in unnecessarily risky manoeuvres late in a match.

The lack of confidence in the quality of the decision of the judges adversely affects the viewing integrity of the sporting contest. Viewers can feel uncertainty at the end of the match as they await the decision of the judges, even when one contestant appears to have provided a dominant performance during the match. Viewers progressively become uneasy as the rounds complete, knowing the result may be determined by the judges and that the viewers are not confident in the quality of the judging.

A better scoring system for sporting contests provides a visual display of the score throughout the contest, so that the contestants, coaches, and the live audience know the current score (against their opponents) as and when the scoring events occur. Such a scoring display system introduces an additional emotional arc throughout the fight, which increases the match intensity and provides a better viewing experience. If the contestants complete all the scheduled rounds they would clearly know the outcome of the fight at the end of the last round.

Providing live scoring in the context of a MMA event informs the contestants of their respective progress throughout the fight and the contestants can adjust their strategies accordingly. If live scoring is visible during a bout, the rules for the bout can be configured to ensure that entertainment value is maintained. For example, rules for a bout may stipulate that the bout is to be terminated before a scheduled time, on the occurrence of one contestant scoring more than a predefined number of points or one contestant scoring more than a predefined number of points more than the other contestant. Such rule changes are only possible if at least the referee is able to see the live score during the bout. Different implementations may allow the audience and contestants to view the live scores. Providing a visible score to the contestants or their coaches during a bout allows the contestants or coaches to adjust their strategies throughout the bout. Terminating a bout early when one contestant has a dominant lead can reduce the negative viewer perception that may arise from battery of the losing contestant in MMA contests.

As noted above, MMA includes striking, wrestling, and grappling techniques. The striking arts have enjoyed extensive television coverage through professional boxing, kickboxing, Olympic Taekwondo, and the like. In contrast, grappling and traditional wrestling, such as Brazilian Ju Jitsu, are less televised fighting styles. Movements practised by Brazilian Ju Jitsu fighters are intricate and are often too subtle to notice for amateur viewers. Two fighters lying on the ground performing various grappling techniques against each other may require extraordinary skill, but can be considered the least entertaining of all the styles to the viewing audience. The techniques, although skilful, display the least amount of animation. To the mainstream television viewer, such wrestling techniques may be seen as the least exciting aspect of an MMA fight, where the fighting momentum is perceived to drop excessively and consequently the entertainment value to the viewers is decreased.

Theatrical versions of wrestling have evolved, in which character development, match controversy, and illegal moves have added additional entertainment value. However, such forms of wrestling are typically judged to be pure entertainment and neither realistic fighting sports nor close representations of a real fight.

MMA viewers favour watching striking moves, particularly those moves that lead to knockouts or submissions. MMA fights that contain a high percentage of grappling receive the least amount of attention from viewers. Further, the viewing audience look for a balance of authenticity and gore. The viewing audience prefer to view an authentic fighting product that best imitates a real life fight situation. Accordingly, MMA rules are constructed to provide a real life fighting experience that is authentic as possible without too much injury and visual gore.

In a real urban street fight, an experienced street fighter typically avoids going to the ground, grappling, or wrestling unless he is able to have his opponent submit quickly. Grappling and wrestling in a street fight is seen as risky activity, as the fighters reduce their abilities to sense the activity occurring in the broader environment. There is a higher possibility that third parties may join the fight, striking the fighters, possibly without warning with “cheap shots”, knowing the fighters are less capable of retaliating as the fighters are already engaged in combat.

In order to maximise the viewing experience, it is important that an MMA referee knows when to pull apart two fighters and restart the match. Timing the fight restarts offers a more authentic urban streetfight-styled entertainment product.

An improved system informs the fighters that the majority of the viewing audience believe a restart of the match is necessary to maintain the entertainment value of the fight and/or authenticity for mimicking an urban streetfight context.

The present disclosure provides a method and system that enables members of the live audience of an event to provide input to assist in judging and refereeing the event.

One implementation provides a computing device adapted to receive input from a member of a live audience of an event. A computer program executing on the computing device is adapted to verify that the viewer is human, to ensure that the inputs are authentic and are not skewed by artificial means, such as a programmed device. In one implementation, the device validates that the viewer is registered to participate in scoring or refereeing the event. In a further implementation, the device is adapted to verify the location of the viewer, such as through an IP address associated with the device, through a geo-positioning module located within the computing device, or other means. In one implementation, inputs received from the viewer are recorded with respect to a universal time clock that can factor for latency and jitter within the connecting networks, so that inputs from different viewers can be correlated.

The viewer feedback system allows a viewer to be involved in judging or scoring an event in real time. In one implementation, viewers of an event allocate points to scoring moves performed during the event. In another implementation, the system displays a running score during the event, wherein the score is derived from input requests received from one or more viewers. Depending on the application, the running score may be visible to the viewing audience, the official(s), the scoring judges, the competitors, or any combination thereof. When displayed to the viewing audience, the score may be displayed to the live audience present at the event venue, on television broadcasts, on smartphones or other computing devices, on the computing device of a scoring viewer, or any combination thereof. In another implementation, the system analyses input requests from viewers and discards those input requests that fail to satisfy predefined criteria. Such criteria may be established to identify inaccurate, biased and/or unacceptable inputs from scoring viewers, based on a statistical majority of received input requests or other analysis.

In one implementation, an event has a set of official scoring judges that is supplemented by an overall crowd score compiled from input requests received from the viewing audience. Each official scoring judge allocates points to scoring moves throughout the event. Similarly, scoring viewers submit input requests corresponding to scoring moves during the event and those input requests are collated to determine the overall crowd score. The overall crowd score may be utilised in conjunction with the sores of the official scoring judges to identify a winner of the event. Alternatively, the overall crowd score may be utilised to identify a winner of a separate “crowd prize”. A further alternative utilises the overall crowd score to determine the winner in the event that the scores of the official scoring judges are drawn.

Providing a crowd score during an MMA fight allows fighters and fighters' coaches to adjust their fight plans during the fight, based on the current score of the fight. This allows for the stronger development of an emotional arc with viewers, as the viewers would continually know the true score/position of each fighter as the fight progresses. This also offers an immediate final result at the end of a scheduled fight with higher levels of viewer acceptability. The provision of a live running score also removes the opportunity for match fixing or judging fraud committed by a small number of judges.

In one embodiment, the viewer feedback system allows viewer(s) to assist the referee or to referee the fight. The system allows viewers (“refereeing viewers”) to determine when fighters need to be separated and the match restarted.

In order to improve viewer confidence in the feedback system, the feedback system optionally provides a system for ranking each refereeing viewer, based on previous performances. The ranking of a viewer is available to other refereeing viewers or members of the viewing audience. A member of viewing audience will have greater confidence in feedback provided by a high ranking refereeing viewer.

One implementation provides an interface that allows a refereeing viewer to submit an input corresponding to a restart of the fight. If a predefined number or percentage of refereeing viewers indicate submit a restart input within a predefined period of time, a signal is provided to an official associated with the event or to the competitors and the competitors are separated and the fight restarted.

One implementation processes restart inputs and determines an appropriate time to trigger a restart event. For example, the system may define a minimum time that must pass from a previous restart before the next restart can be signalled. The system may apply weights to restart inputs of different refereeing viewers, based on the individual rankings of those refereeing viewers or the location of the refereeing viewers. One implementation allocates a higher weighting to inputs received from refereeing viewers physically present at the event venue and lower weightings to viewers at remote locations.

In another implementation, the system analyses refereeing input requests from viewers and discards those input requests that fail to satisfy predefined criteria. Such criteria may be established to identify inaccurate, biased and/or unacceptable inputs from scoring viewers, based on a statistical majority of received input requests or other analysis.

In one implementation, the system triggers a restart event once a predefined aggregate number of viewer requests has been satisfied. In another implementation, the system utilises a crowd initiated timer for fighters to separate or be separated. In one embodiment, an alert device is provided at a venue. The alert device is utilised to inform the contestants of a forthcoming event, such as interaction by the referee. In one example, the alert device is a visual display that is viewable by the referee, the contestants, and the audience present at the venue. In an alternative example, the alert device is an audible device, such as a siren or buzzer that increases in frequency or volume before the forthcoming event. In a further example, a combination of a visual display and an audible device is utilised.

The visual display may be implemented using one or more computer displays to ensure that at least one of the computer displays is visible to all or a significant portion of the audience present at the venue. In this example, the alert device provides a visual timer to the referee and the contestants that a restart event will occur when the timer expires. For example, the timer is set to 3 seconds and counts down from 3 seconds to 2 seconds to 1 second to 0, at which time the referee initiates a restart. The restart event might be, for example, a separation of two contestants in an MMA bout that have been in a clinch or grapple.

One embodiment provides a sliding window of time in relation to viewer requests to have the referee separate two fighters and restart a bout. If a predefined portion of the viewing audience votes for a restart within any predefined period of time, an alert device is triggered and the bout is restarted.

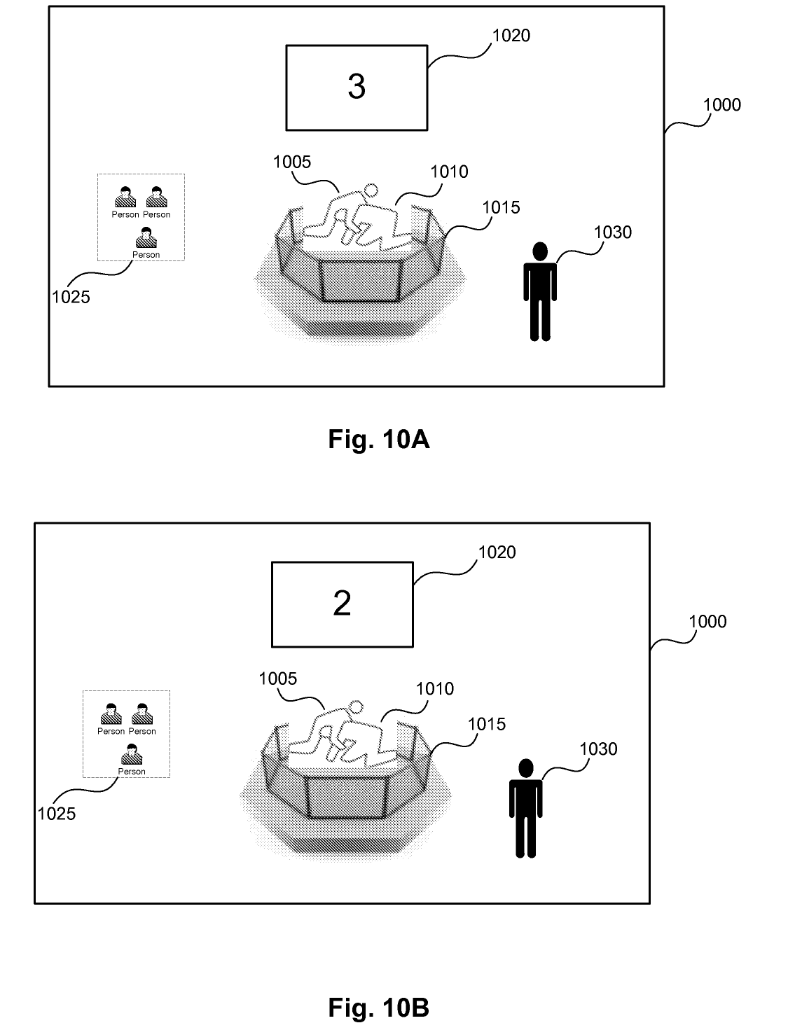

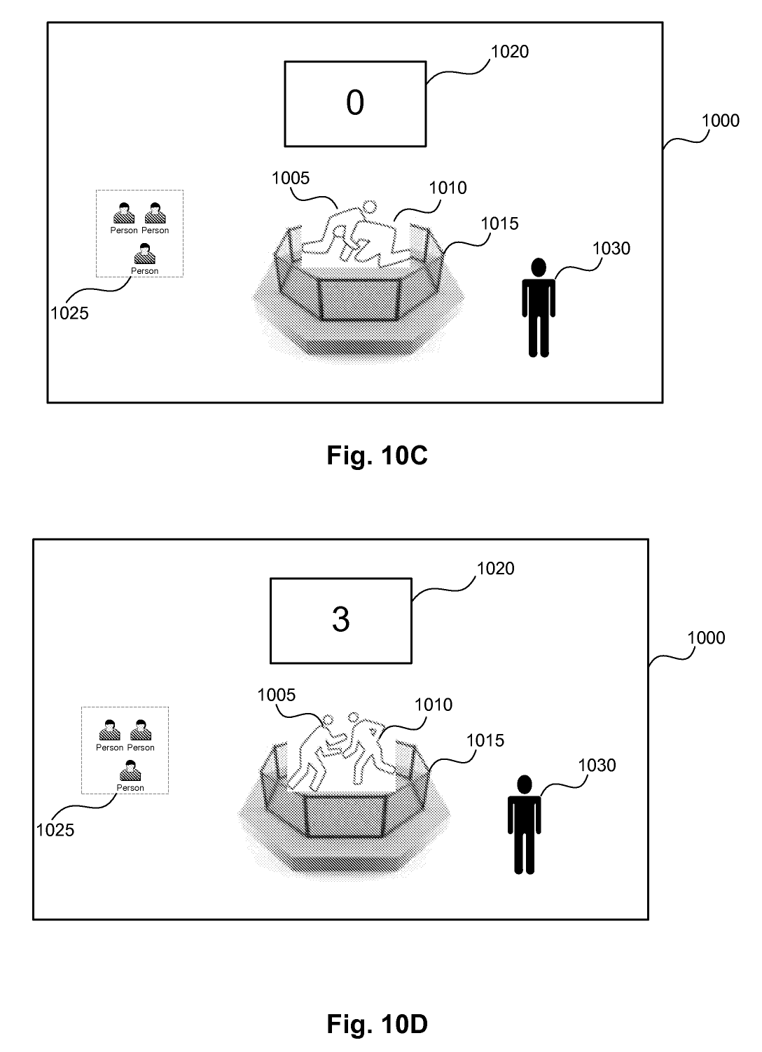

FIGS. 10A-10D are schematic representations illustrating use of an alert device in the form of a visual display. FIG. 10A shows a venue 1000 hosting an MMA bout between a first contestant 1005 and a second contestant 1010 in an MMA ring 1015. The venue 1000 includes an alert device 1020 in the form of a visual display. In this example, the visual display 1020 is viewable by the first contestant 1005, the second contestant 1010, a referee 1030, and a live audience 1025 present at the venue 1000.

In FIG. 10A, the first contestant 1005 and the second contestant 1010 are involved in a grapple, which is considered to be a less exciting form of combat and thus less desirable to the viewing audience 1025. In this example, the visual display 1020 shows a restart timer, which is initially set to 3 seconds. During the bout, members of the viewing audience, either present at the venue 1000 or watching a live broadcast, utilise a computing device to provide input requests relating to the scoring or refereeing of the bout. In order to provide input requests, viewers register in respect of the particular event. If a predefined number or proportion of the registered viewers provides an input request corresponding to a restart within a predefined window of time, such as 15 seconds, the timer on the visual display 1020 is triggered and begins to count down.

FIG. 10B shows the first and second contestants 1005, 1010 still in a grapple and the timer on the visual display 1020 has decreased to 2 seconds. If the first and second contestants 1005, 1010 separate during countdown of the timer, an official resets the timer to 3 seconds and the predefined window of time resets.

FIG. 10C shows the first and second contestants 1005, 1010 still in a grapple when the timer on the visual display 1020 reaches 0. When the timer reaches 0, the referee 1030 separates the contestants 1005, 1010. To assist the referee, the timer reaching 0 may be accompanied by a further warning, such as a flashing light, a light of a different colour, an audible warning, or any combination thereof.

FIG. 10D shows that the first contestant 1005 and the second contestant 1010 have been separated and the bout restarted. The visual display 1020 shows that the timer has been reset to 3 seconds.

Depending on the application, an input request submitted by a viewer may be presented to any one or more of an event official, such as one or more of the venue referee and/or fight host(s), the live audience present at the event venue, to viewers of a television broadcast, an application running on mobile computing devices, such as the smartphone or tablet device 910 of FIG. 9, or a computing device associated with the refereeing viewer.

A feedback system that enables members of a viewing audience to contribute to the scoring and refereeing of an event increases the entertainment value of the event. In the case of a fight, the striking cadence of the fight is maintained at a level desired by the viewing audience. Further, aspects of a fight that are determined by a viewing audience to be less entertaining, such as excessive grappling, wrestling, or clinching would be reduced in count and duration due to participation of members of the viewing audience.

Increasing the number of restarts, in response to viewer feedback, improves the fight's viewing experience, as the fight has more viewer anticipation as fighters near each other after a restart, increased fighter animation due to the increase in striking opportunities presented by a restart, and the fight is a closer approximation to an urban street fight scenario.

Refereeing inputs provided by the viewing audience may be configured on an event basis, and may include, for example, other refereeing decisions such as starts, stoppages, and adjudication of illegal moves.

One embodiment allows contestants to request an instant re-match following an initial match. The viewing audience decides whether to allow the instant re-match by submitting votes within a predefined period of time following the initial match.

One embodiment provides a system for interactive viewer feedback that includes a network of one or more computer servers for receiving input requests from viewers during live events. Viewers wanting to provide input to the judging or refereeing of the event register with an administrator of the system. The registered users utilise a computing device to provide input requests during the event. The computing device may be implemented using, for example, a portable computing tablet, a smartphone, a laptop, a desktop computer, or an Internet-television. The computer device may be utilised to access a website hosted in association with the computer servers or alternatively may access a software application executing on a processor of the computing device.

During the live event, registered viewers provide input requests relating to the judging and refereeing of the event. The computing device accessed by a registered viewer transmits the input request to one of the network of servers. A server receives the input request and determines the latency between the computing device and the server, and corrects for the latency so that the input request is associated with an event in the live event. The servers correct for latency in all of the received input requests, so that input requests are collated correctly against the relevant event in the live performance.

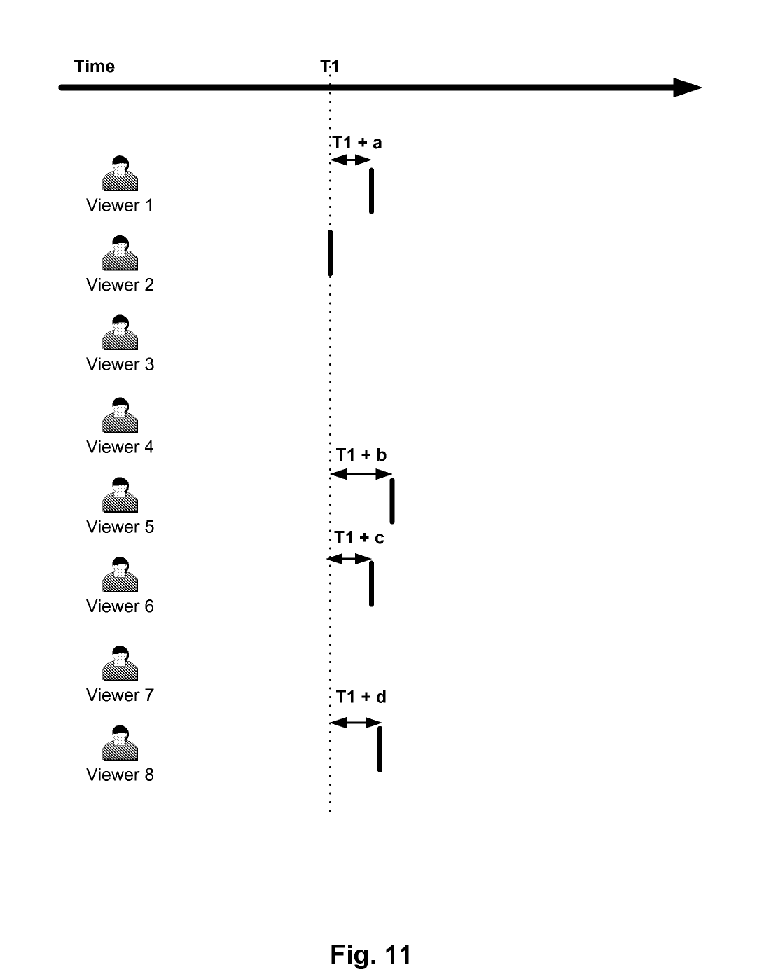

FIG. 11 is a schematic diagram representation illustrating the presence of latency in a set of input requests received from a viewing audience of a live MMA match between Fighter A and Fighter B, in response to an event during that match. In this example, the event is a strike from Fighter A to Fighter B at time t=T1.

In this example, the viewing audience includes a set of 8 viewers who have registered with a server providing an interactive feedback system. Each of the set of 8 registered viewers is able to provide input requests relating to a strike from Fighter A to Fighter B. The 8 registered viewers watch the match and, at time t=T1, 5 of the registered viewers (Viewers 1, 2, 5, 7, and 8) award a strike to Fighter A by using a user interface on an application executing on a respective computing device. The Viewers 1, 2, 5, 6, and 8 are located at varying distances from the server and may utilise different communication networks to transmit input requests from their respective computing devices to the server. Consequently, the input requests from Viewers 1, 2, 5, 6, and 8 arrive at the server at different times on or shortly after the strike occurred at time t=T1.

In this example, FIG. 11 shows that the server received an input request from Viewer 1 at time T1+a, an input request from Viewer 2 at time T1, an input request from Viewer 5 at time T1+b, an input request from Viewer 6 at time T1+c, and an input request from Viewer 6 at time T1+d. The server receives multiple input requests from all of the Viewers 1-8 during registration for the match and during the match. The server determines the latency that is present in the communication network utilised by each of the Viewers 1 to 8 and adjusts received inputs by a relevant amount to correct for the different latencies to produce a correlated set of input requests relative to events that occur throughout the match.

The server is also adapted to filter input requests from registered viewers to identify and discard input requests that are determined to be statistically erroneous. For example, if a fan of Fighter A provides an input request corresponding to a strike by Fighter A at a time that does not correspond to a strike occurring in the match and during a time period where few or no other registered viewers provided an input request corresponding to a strike by Fighter A, the server will identify the input request from that fan as being an anomalous entry and input requests provided by that fan will be discarded.

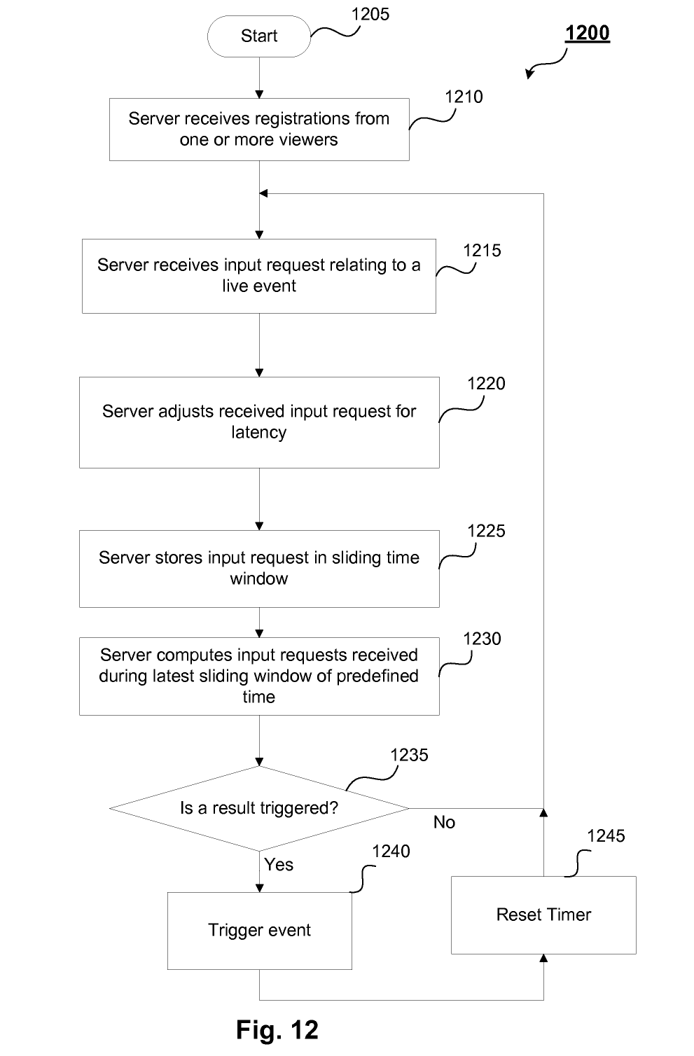

FIG. 12 is a flow diagram illustrating a method 1200 of processing an input request in an interactive feedback system. The method 1200 begins at a Start step 1205 and proceeds to step 1210, in which a server used in the implementation of an interactive feedback system receives and processes registrations from one or more viewers. Control passes to step 1215, in which the server receives an input request from a registered viewer. The input request may relate, for example, to a judging or refereeing input. Valid inputs may be controlled by a user interface of a software application executing on a computing device utilised by the registered viewer to provide the input request.

In the example of FIG. 12, the input request relates to a refereeing input. In particular, the input request relates to the initiation of a restart of a match in response to a grapple. Control passes from step 1215 to step 1220, in which the server adjusts the received input request for latency, jitter, or a combination thereof. In step 1225, the server stores the received input request in the current predefined window of time for determining whether a restart event is triggered. If a predefined portion of registered viewers transmit input requests corresponding to a restart within a predefined window of time, a restart event is triggered.

In step 1230, the server computes whether the predefined portion of registered viewers have transmitted a restart request within the latest predefined window of time. If the predefined portion of registered viewers has requested a restart, Yes, control passes to step 1240, which triggers a restart event. In one implementation, triggering a restart event involves the commencement of a countdown timer. When the timer expires, an official separates the contestants and the match restarts. Control passes from step 1240 to step 1245, which resets the countdown timer. Control returns from step 1245 to step 1215 for the server to receive further input requests.

Returning to step 1235, if a predefined portion of registered viewers has not transmitted a restart request within the predefined window of time, No, control returns from step 1235 to step 1215 for the server to receive further input requests.

In one embodiment, the server stores data relating to the past judging and refereeing performances of each registered viewer. Correlating performances against professional judges and referees and the performances of fellow registered viewers provides an indication of how reliable each registered viewer is as a judge and referee. One implementation awards different levels of status to a registered viewer based on the relative number of matches judged and refereed and how well the performances correspond to other viewers, judges, and referees.

One implementation optionally attaches a weighting to input requests received from registered viewers that have attained different status levels. Applying such weighting adds credibility to an input request received from a registered viewer that is deemed to have judged or refereed well over a period of time. An alternative implementation applies a weighting to input requests provided by members of the live audience physically present at a venue during an event. Such a weighting enables the audience physically present at the venue to have a greater vote in how the event progresses.

As described with reference to step 110 of FIG. 1, the viewer feedback system optionally provides for input requests to be received from prospective audience members before an event occurs. In one example, viewers are able to lodge input requests corresponding to parameters of the event. Such parameters in relation to a fight may include fight style rules, duration, and number of rounds for the match.

A further embodiment provides viewing members with additional information relating to the fighters or event via an application executing on a computing device. The additional information may include, for example, physical statistics of the contestants, statistics relating to the event venue, a catalogue of past performances, and statistics relating to past performances of the contestants. The additional information may also be determined from sensors employed during the event to deliver real-time statistics acquired during the event, such as heart rates, fighter health status, fighter movements, and strike pressures, both received and/or delivered.

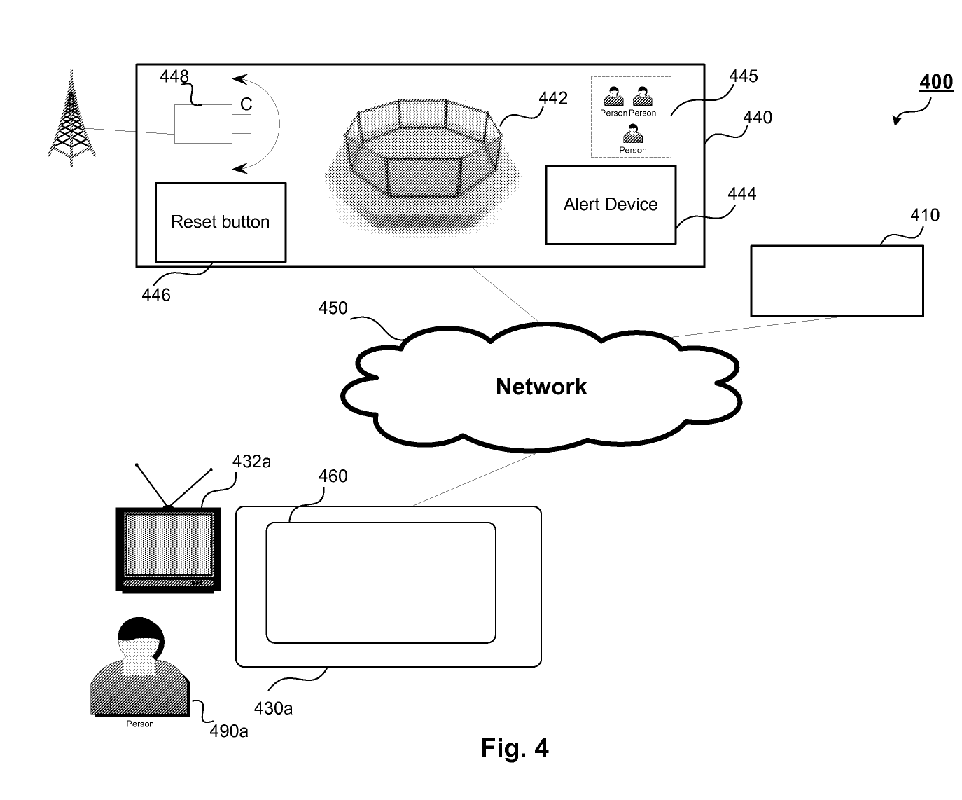

FIG. 4 is a schematic block diagram representation of an interactive feedback system 400 for judging an event. In this example, the event is an MMA fight. The system 400 includes an event venue 440 that includes an MMA ring 442 and a feedback device 444 in the form of a dynamic score board for providing live scores of the respective fighters during the fight. The event venue 440 also includes an official 454 and two competitors 456a, 456b. The event venue 440 further includes a receiver 454 for receiving information transmitted from a server 410 over a communications network 450.

The server 410 may be implemented using the server 310 of FIG. 3 and is adapted to register details of an event, including the date and time of the event, participants, and officials. The server 410 is further adapted to register details of viewers who wish to participate in judging the MMA fight conducted at the event venue 440.

The system 400 further includes a viewer 490 watching the event, either live at the venue 440 or at a remote location on a display adapted to receive a broadcast transmission of the event. In this example, the viewer 490 is watching a television broadcast of the event on a first television 432a.

The viewer utilises a first computing device 430a to provide information relating to judging of the MMA fight. In this example, the computing device is a smartphone, laptop, desktop computer, or tablet device running a computer program for facilitating viewer feedback. The computer program provides an interface on the computing device 430a that displays a predefined set of valid scoring moves 460 that the viewer 490 can score during the event. The interface is enabled only during the time at which the event is occurring, so that the viewer 430a is only able to provide judging inputs during the live event and not before or after.

In this example, the set of valid scoring moves 460 includes a matching set of scoring moves for each of the two competitors in the MMA fight. During the event, the viewer 430a selects one of the scoring moves corresponding to the relevant competitor when the viewer 430a judges that that competitor has performed that scoring move. The computing device 430a transmits inputs provided to the computing device 430a by the viewer 490 to the server 410. The server 410 processes the received inputs and sends information derived from the processed inputs via the communications network 450 to the event venue 440. In this example, the information derived from the processed inputs corresponds to the score of the MMA fight and the score is displayed on the dynamic score board 444. In this example, the dynamic score board 444 is visible to the competitors 456a, 456b and thus the competitors 456a, 456b know who is winning throughout the fight. The dynamic score board 444 may also be visible to members of the live audience present at the event venue 440 and presented as a graphic or visible in video images broadcast to viewers in remote locations.

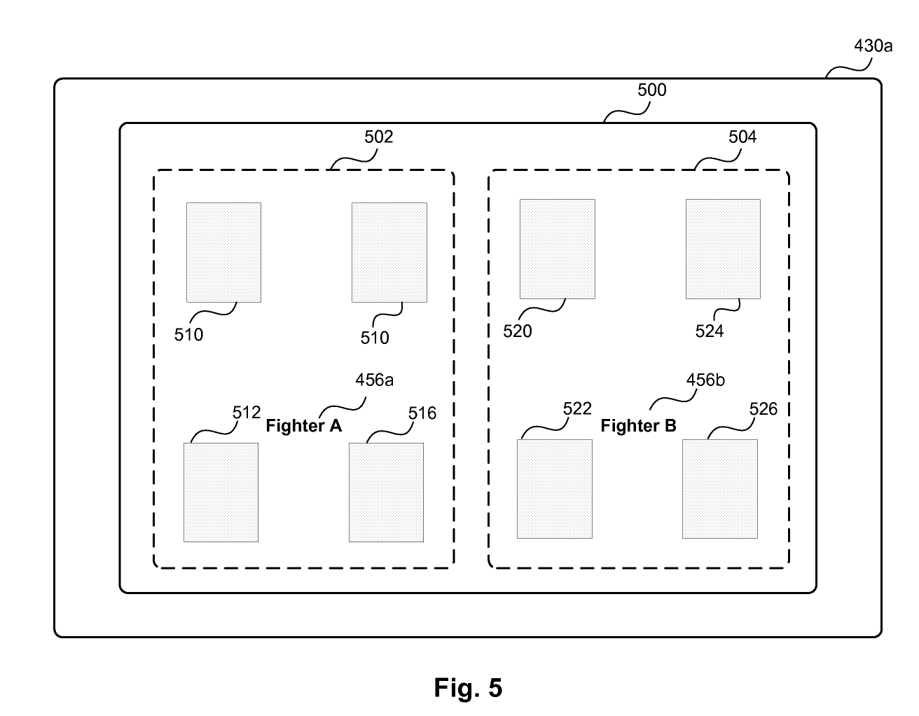

FIG. 5 is a schematic block diagram representation of the computing device 430a of FIG. 4 displaying an interface 500 of a predefined set of predefined actions or scoring moves 460 for use in judging an event. In the example of FIG. 5, the interface 500 is divided into first and second portions of the display screen 502, 504 corresponding to the two fighters 456a, 456b, respectively. The actions or scoring moves may include, for example, in relation to an MMA match, striking, takedowns, reversals, submissions, and transitions.

The first portion of the display screen 502 corresponds to Fighter A 456a and shows a set of possible scoring moves 510, 512, 514, 516 associated with Fighter A 456a. The set of possible scoring moves represent moves for which an audience member may award a score during the event when that move is performed by the corresponding fighter. The second portion of the display screen 504 corresponds to Fighter B 456b and shows a set of possible scoring moves 520, 522, 524, 526 associated with Fighter B 456b. Thus, when a viewer watching the fight sees Fighter A 456a effect a scoring move, such as a predefined strike or grapple, corresponding to the scoring move 510 displayed on the interface 500, the viewer selects the scoring move 510 and the computing device transmits a corresponding input to the server 410. The interface 500 will depend on the event, as different types of events may have different scoring moves.

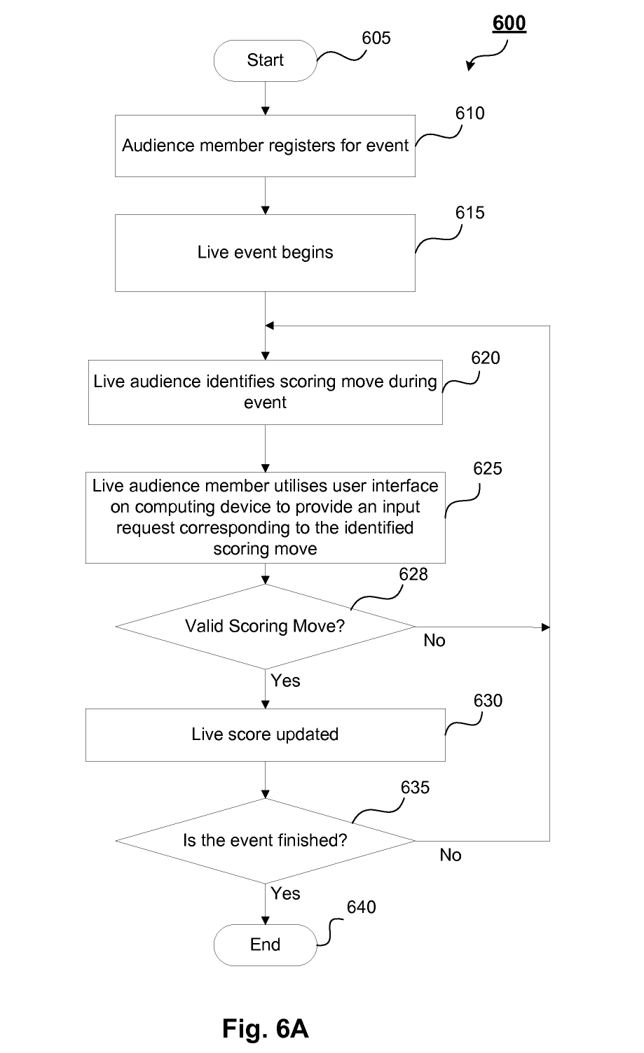

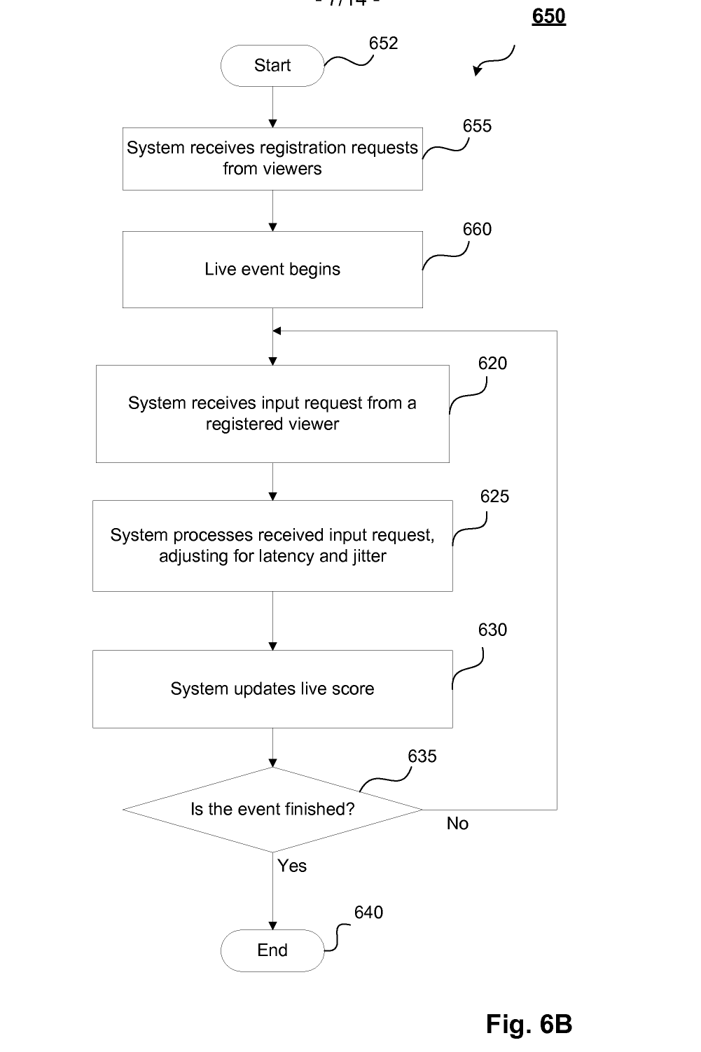

FIG. 6A is a flow diagram of a method 600 of processing feedback from one or more members of a live audience to judge an event. The method 600 begins at a Start step 605 and proceeds to step 610 in which an audience member registers with an interactive feedback system in respect of a particular event. Control passes to step 615, in which the event begins.

Control passes from step 615 to step 620, in which the registered audience member watches the event and identifies a scoring move executed by a contestant of the event. In step 625, the registered audience member utilises a user interface on a computing device to provide an input request to the interactive feedback system relating to the identified scoring move. In step 628, the system optionally determines whether the input request provided by the registered audience member corresponds to a valid scoring move. In one implementation, a valid scoring move is determined by a minimum number or proportion of the registered viewing audience providing an input request corresponding to that same scoring move within a predefined period of time. In one example, the predefined period of time is known as a scoring window and is set to 1 second and the proportion of the registered viewing audience required to validate a scoring move is 45%. Thus, if fewer than 45% of the registered viewing audience provide an input request corresponding to a scoring move within 1 second of the scoring move incident occurring in the live event, that scoring move is deemed to be valid. Alternatively, the scoring move is deemed not to be valid and the score will not be updated.

If step 628 determines that the input request from step 625 does not correspond to a valid scoring move, No, control returns to step 620. Alternatively, if step 628 determines that the input request from step 625 does correspond to a valid scoring move, Yes, control passes to step 630.

As noted, the validation of the scoring move in step 628 is optional. In one embodiment, there is no validation of the scoring move and the interactive feedback system calculates a score corresponding to each registered audience member. In another embodiment, validation of scoring moves is performed and the interactive feedback system calculates a single score based on the validated scoring moves. In such an embodiment, a single audience score is only able to be increased when a predefined number or proportion of the registered viewing audience provide an input request corresponding to a scoring move within a predefined period of time of the scoring move occurring.

In step 630, the interactive feedback system updates a live score associated with the event. In one implementation, the live score is visible to the contestants. In one implementation, the live score is displayed on a visual display at the event venue and the live score is available for display on a computing device accessed by a registered audience member.

Control passes from step 630 to decision step 635, which determines whether the event has finished. If the event has not finished, No, control returns to step 620 and the registered audience member is able to identify and score further scoring moves. However, if at step 635 the event has finished, Yes, control passes to an End step 640 and the method 600 terminates.

FIG. 6B is a flow diagram illustrating a method 650 of processing by a system of viewer feedback to judge an event. The method 650 begins at a Start step 652 and proceeds to step 655 in which an interactive feedback system receives one or more registration requests from audience members wanting to participate in relation to a forthcoming event. The system may be implemented, for example, using the server 310 of FIG. 3. For each received registration request, the server 310 validates the requesting audience member against the registered user database 312. The server 310 may, for example, verify a user name and password associated with a previously registered audience member. Alternatively, the server 310 allocates a user identifier and password to an audience member registering for the first time. Details relating to each registered audience member are stored in the registered user database 312 and include, for example, name, password, sporting preferences, history of judging performances, history of refereeing performances, and a list of forthcoming events for which that audience member is registered.

The server 310 also validates each registration request against the event database 316 to ensure that the requested event exists, that registration to the requested event is still available, and to confirm that the event is still scheduled to occur. Depending on the type of event, registration may optionally provide the registering audience member with an opportunity to provide an initial input request. In the example in which the event is a musical concert by an artist, the server 310 optionally provides the registering audience member with an opportunity to provide a play list of one or more songs by the artist.

Returning to FIG. 6B, control passes from step 655 to step 660 and the event begins. Control passes to step 620, in which the system receives an input request from a registered audience member. In step 625, the system processes the received input request, adjusting the input request for latency and jitter. Using the example of FIG. 3, the server 310 utilises the latency module 328 to correct for latency and jitter. Depending on the implementation, correcting latency and jitter is necessary to ensure that input requests received in respect of a particular incident during a live event are related to the correct incident. The system processes the input request by determining the nature of the request.

In this example, the input request relates to a scoring move identified by the registered audience member. In step 630, the system updates a live score associated with the event. As described with reference to FIG. 6A, depending on the implementation the live score is displayed at the event venue and on computer devices accessible by registered audience members, or a combination thereof.

It can be seen from FIG. 6A and FIG. 6B that the interactive feedback system enables a registered audience member to view an event and provide feedback that has a direct result on a score associated with that event. Depending on the implementation, the score affected by inputs received from registered audience members may be the only score or may be utilised in conjunction with other scores, such as one or more scores provided by official judges. Either way, members of the registered audience are involved in determining an outcome of the event and have a greater sense of trust in that score.

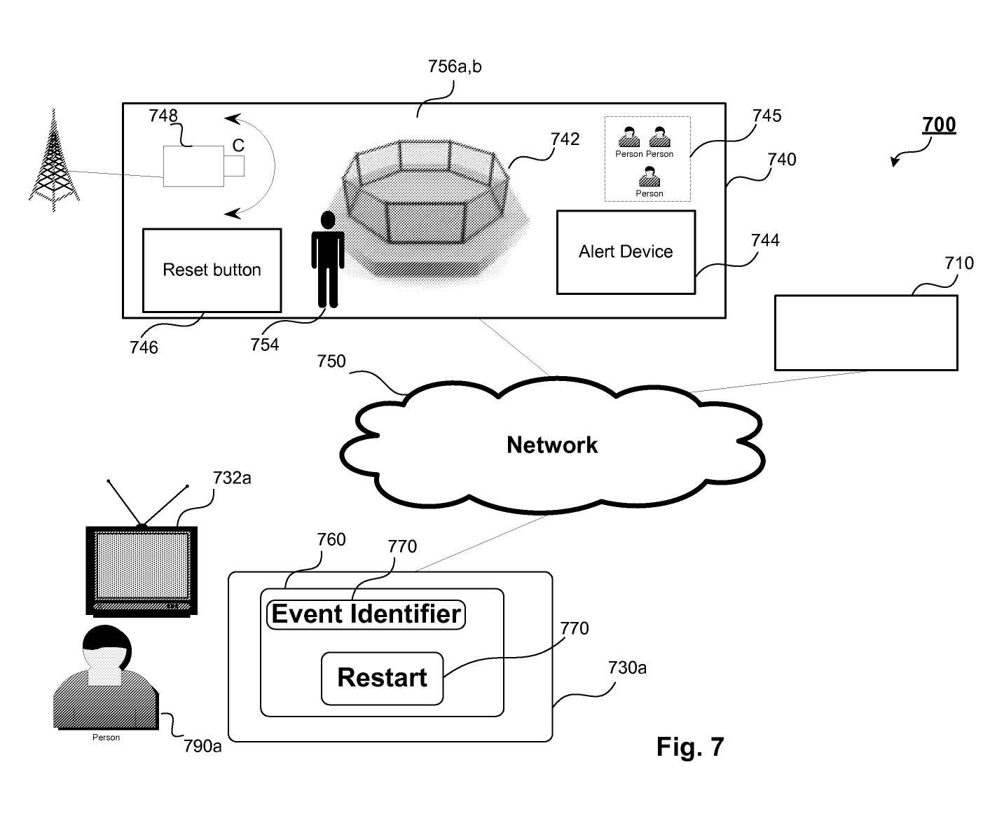

FIG. 7 is a schematic block diagram representation of an interactive feedback system 700 for refereeing an event. In this example, the event is an MMA fight. The system 700 includes an event venue 740 that includes an MMA ring 742 and a feedback device 744 in the form of a dynamic score board for providing live scores of the respective fighters during the fight. The event venue 740 also includes an official 754 and two competitors 756a, 756b. The event venue 740 further includes a receiver 754 for receiving information transmitted from a server 710 via a communications network 750.

The server 710 may be implemented using the server 310 of FIG. 3 and is adapted to register details of an event, including the date and time of the event, participants, and officials. The server 710 is further adapted to register details of viewers who wish to participate in refereeing the MMA fight conducted at the event venue 740.

The system 700 further includes a viewer 790 watching the event, either live at the venue 740 or at a remote location on a display adapted to receive a broadcast transmission of the event. In this example, the viewer 790 is watching a television broadcast of the event on a first television 732a.

The viewer 790 utilises a first computing device 730a to provide information relating to refereeing of the MMA fight. In this example, the computing device is a smartphone, laptop, desktop computer, or tablet device running a computer program for facilitating viewer feedback. The computer program provides an interface on the computing device 730a that displays a predefined set of refereeing instructions 760 that the viewer 790 can utilise during the event. The interface is enabled only during the time at which the event is occurring, so that the viewer 790 is only able to provide refereeing inputs during the live event and not before or after.

In this example, the set of valid refereeing instructions 760 includes an instruction to restart the match by separating the fighters 756a, 756b and having the fighters 756a, 756b resume from a starting position. During the event, the viewer 730a selects the restart instruction when the viewer 790 judges that that competitor has performed that scoring move. The computing device 730a transmits inputs provided to the computing device 730a by the viewer 790 to the server 710. The server 710 processes the received inputs and sends information derived from the processed inputs via the communications network 750 to the event venue 740. In this example, the information derived from the processed inputs corresponds to a refereeing instruction to restart the MMA fight and the instruction to restart is displayed on the dynamic score board 744. In this example, the dynamic score board 744 is visible to the official 754 and thus the official 754 knows to separate the fighters 756a, 756b. The dynamic score board 744 may also be visible to the fighters 756a, 756b, members of the live audience present at the event venue 740, and may also be presented as a graphic or visible in video images broadcast to viewers in remote locations.

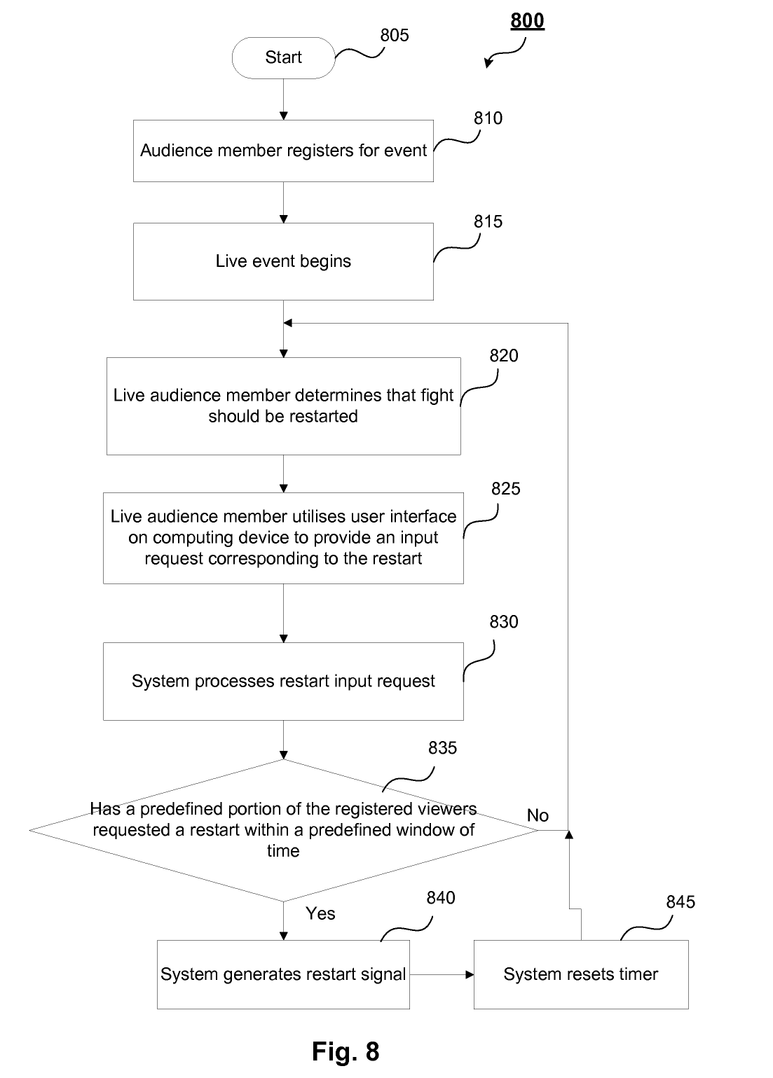

FIG. 8 is a flow diagram of a method 800 of processing feedback from one or more members of a live audience to referee an event. In this example, the event is an MMA match and registered audience members are able to provide input requests at any time to request that two fighters in the MMA match are separated through a restart of the match.

The method 800 begins at a Start step 805 and proceeds to step 810, in which an audience member registers with an interactive feedback system to provide feedback relating to refereeing of the MMA match. Control passes from step 810 to step 815, in which the MMA match begins. In step 820, the registered audience member decides that the two fighters in the MMA match should be separated from a clinch. In step 825, the registered audience member utilises a computing device to access a user interface provided by a software application executing on a processor of the computing device. The user interface provides the registered audience member with one or more input options. In this example, the user interface includes a button corresponding to an instruction to separate the fighters and restart the MMA match.

The registered audience member presses the button, which causes the computing device to transmit a corresponding input request to the interactive feedback system. In the example of FIG. 3, the interactive feedback system is implemented using a server 310, which in step 830 receives the input request transmitted by the computing device accessed by the registered audience member. The server 310 adjusts the input request for latency and jitter and processes the content of the input request.

In step 835, the server 310 determines whether a predefined portion of the registered audience has lodged a request to separate the fighters within a predefined window of time. In one example, the predefined window of time is 15 seconds and the predefined portion of the registered audience is 34%. Thus, when 34% of the registered audience submit an input request asking for the fighters to be separated within any 15 second period, a restart event is triggered. Returning to step 835, if a predefined portion of the registered audience has not requested a restart within the predefined time period, No, control returns to step 820. If at step 835 a predefined portion of the registered audience has requested a restart within a predefined period, Yes, control passes to step 840, in which the system generates a restart signal. In the example of FIG. 3, the server 310 sends a signal to the alert device 344 to display a countdown timer to the fighters and the live audience members present at the event venue 340. In one implementation, the alert device initiates a 3 second countdown timer and at the expiry of the timer an official separates the fighters and restarts the match. Control passes from step 840 to step 845, in which the system resets the timer for the predefined window, so that at least the predefined period of time will pass before a next restart event can be initiated by the registered audience members.

The arrangements described are applicable to the entertainment, computer and data processing industries and particularly for the live entertainment and sporting industries.

The foregoing describes only some embodiments of the present invention, and modifications and/or changes can be made thereto without departing from the scope and spirit of the invention, the embodiments being illustrative and not restrictive.

In the context of this specification, the word “comprising” and its associated grammatical constructions mean “including principally but not necessarily solely” or “having” or “including”, and not “consisting only of”. Variations of the word “comprising”, such as “comprise” and “comprises” have correspondingly varied meanings.

As used throughout this specification, unless otherwise specified, the use of ordinal adjectives “first”, “second”, “third”, “fourth”, etc., to describe common or related objects, indicates that reference is being made to different instances of those common or related objects, and is not intended to imply that the objects so described must be provided or positioned in a given order or sequence, either temporally, spatially, in ranking, or in any other manner.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. In certain particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the invention can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general purpose computer to turn the general purpose computer into a special purpose computer implementing elements of the invention. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud computing environment” is an environment in which cloud computing is employed.

Although the invention has been described with reference to specific examples, it will be appreciated by those skilled in the art that the invention may be embodied in many other forms.

I claim:

1. A method for facilitating audience feedback during an event, comprising the steps of:
receiving at least one input request from a set of registered audience members of said event, said request relating to a predefined set of actions;
processing, using at least one processor, said received requests; and
presenting information during said event, based on said processed requests.

2. The method according to claim 1, wherein said predefined set of actions includes a set of scoring moves or a set of judging criteria.

3. The method according to claim 1, wherein said information relates to at least one of judging, refereeing, and scoring of said event.

4. The method according to claim 1, wherein said information is displayed to at least one of an official, competitors of the event, members of the audience present at an event venue, and viewing members of a broadcast of the event.

5. The method according to claim 1, wherein presenting information includes displaying a visual indication on an alert device located at a venue associated with said event, wherein said alert device includes at least one of a visual warning device and an audible warning device.

6. The method according to claim 1, wherein processing said received requests includes adjusting each received request for at least one of latency and jitter.

7. The method according to claim 1, wherein at least one of said input requests is received during said event.

8. The method according to claim 1, comprising the further step of:
refereeing said event at least partially, based on said presented information.

9. The method according to claim 1, wherein processing said received requests includes the steps of:
validating each received request, based on said received request being received within a predefined period of time of an incident in said event.

10. The method according to claim 9, wherein validating each received request is further based on whether said received request relates to a first action from said set of actions that corresponds to said incident.

11. The method according to claim 10, wherein validating each received request is further based on whether a predefined number of registered audience members provided requests relating to said first action within said predefined period of time.

12. An interactive feedback system server comprising:
a memory for storing data and a computer program;
a processor coupled to said memory for executing said computer program stored in said memory;
a registered user database for storing viewer information associated with at least one registered viewer;
an event database for storing event information relating to at least one scheduled event;
an interactive feedback application forming part of said computer program, said interactive feedback application including instructions for performing the method steps of:
registering at least one of said registered viewers as a registered audience member in respect of an active event selected from at least one of said scheduled events;
receiving at least one input request from at least one of said registered audience members during said active event, said request relating to a predefined set of actions;
processing said received input requests; and
presenting information during said event, based on said processed requests.

13. The interactive feedback system server according to claim 12, further comprising:
a latency module for adjusting at least one of latency and jitter associated with each received input request.

14. The interactive feedback system server according to claim 12, further comprising:
a weighting module for applying a weighting to a received input request, based on a registered audience member associated with said input request.

15. The interactive feedback system server according to claim 12, wherein said weighting module applies a weighting to a received input request based on a stored performance of said registered audience member, said stored performance relating to at least one or judging and refereeing at least one past scheduled event.

16. An interactive feedback system comprising:
a communications network;
an alert device located at a venue associated with a live event;
an interactive feedback server coupled to said communications network, said interactive feedback server adapted to process input requests relating to at least one of judging and refereeing of said live event and further adapted to present information to said alert device based on said processed input requests; and
a computing device for receiving an input request from a registered audience member and transmitting said input request to said interactive feedback server via said communications network.

17. The interactive feedback system according to claim 16, wherein said alert device includes at least one of a visual display and an audible warning device.

18. The interactive feedback system according to claim 16, wherein said computing device includes a software application executing on a processor of said computing device to provide a user interface to said registered audience member, said user interface defining a valid set of inputs for said input request.

19. The interactive feedback system according to claim 16, wherein said alert device is visible by contestants in said live event.

20. The interactive feedback system according to claim 16, wherein said alert device is visible by an official associated with said live event.
